(19) United States
(12) Patent Application Publication
(10) Pub. No.: US 2026/0030687 A1
(43) Pub. Date: Jan. 29, 2026

(54) Advanced Insurance Policy Simulation and Analysis Tool

(71) Applicant: Illumine Analytics, LLC, Charlotte, NC (US)

(72) Inventors: Brendan Costello, Lake Oswego, OR (US); Wayne Erik Eklund, Charlotte, NC (US); Aaron Janssen, Bend, OR (US); Adam Sendzischew, Pinecrest, FL (US)

(21) Appl. No.: 19/279,408

(22) Filed: Jul. 24, 2025

Related U.S. Application Data
(60) Provisional application No. 63/675,006, filed on Jul. 24, 2024.

(51) Int. Cl. G06Q 40/08; G06Q 10/0639; G06T 11/20

(52) U.S. Cl. CPC G06Q 40/09; G06Q 10/0639; G06T 11/206

(57) ABSTRACT

This invention relates to a comprehensive tool for simulating, analyzing, and reporting on permanent life insurance policy performance under various economic conditions, insurance companies, and stakeholder and policyholder behaviors. The tool enables the creation of baseline policy illustrations and various financial models incorporating life insurance, validates projections against known and hypothetical data, and simulates future scenarios to provide actionable insights for policyholders and advisors.

### RELATED APPLICATIONS

This application claims priority to U.S. provisional Application No. 63/675,006 having a filing date of Jul. 24, 2024, which is incorporated herein by reference in its entirety.

### BACKGROUND OF THE INVENTION

Traditional insurance policy analysis tools often fail to account for the dynamic nature of economic conditions, insurance companies, and stakeholder and policyholder behaviors.

### BRIEF SUMMARY OF THE INVENTION

This invention aims to fill the gap in traditional products by providing a robust simulation model that integrates these factors to produce more accurate and useful projections.

The invention comprises a tool that can:
1. Incorporate various financial models incorporating life insurance illustrations.
2. Create baseline insurance policy illustrations.
3. Validate policy projections against known data.
4. Simulate policy performance under various economic scenarios.
5. Model policyholder behaviors including premium payments, loans, and withdrawals.
6. Model insurance companies and other stakeholder behaviors, including changing insurance charges and other non-guaranteed elements of life insurance contracts and other interest rates and contract terms.
7. Report on the probability of policy performance or other financial model outcomes.
8. Interface with external data sources via APIs to obtain up-to-date economic, policy, customer, and other relevant data.

### BRIEF DESCRIPTION OF SEVERAL VIEWS OF THE DRAWINGS

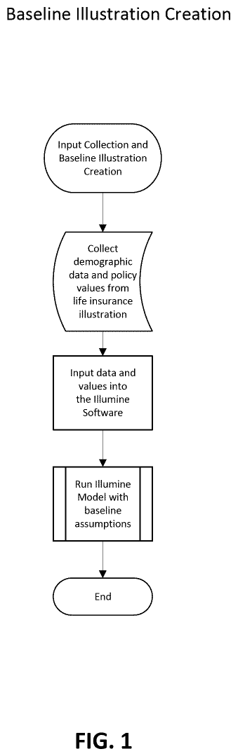

FIG. 1. Flowchart of Input Collection and Baseline Illustration Creation:
Show steps for collecting demographic and policy information.
Detail the process of creating baseline illustrations using mortality tables and policy parameters.

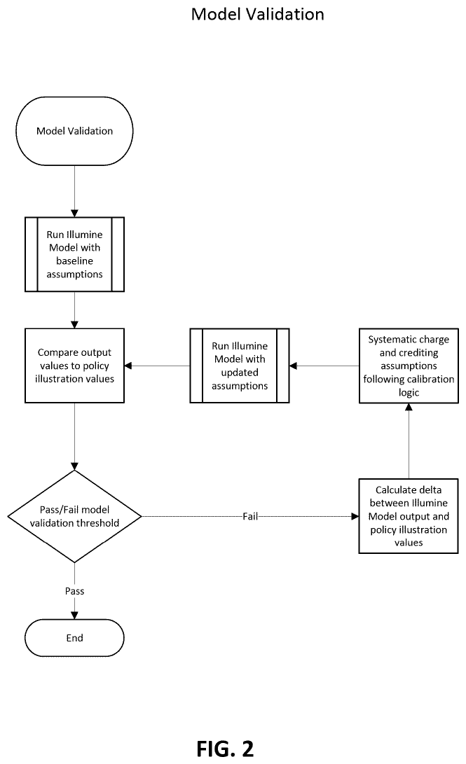

FIG. 2. Model Validation Process Diagram:
Illustrate the iterative process of aligning model outputs with policy illustrations.
Highlight the use of algorithms to adjust charges and credits.

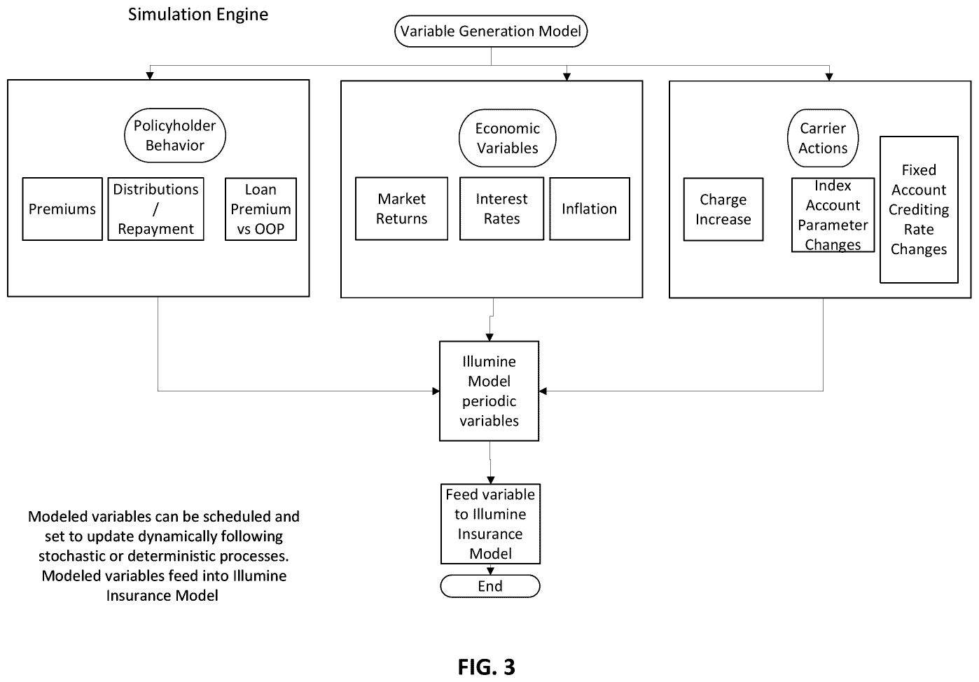

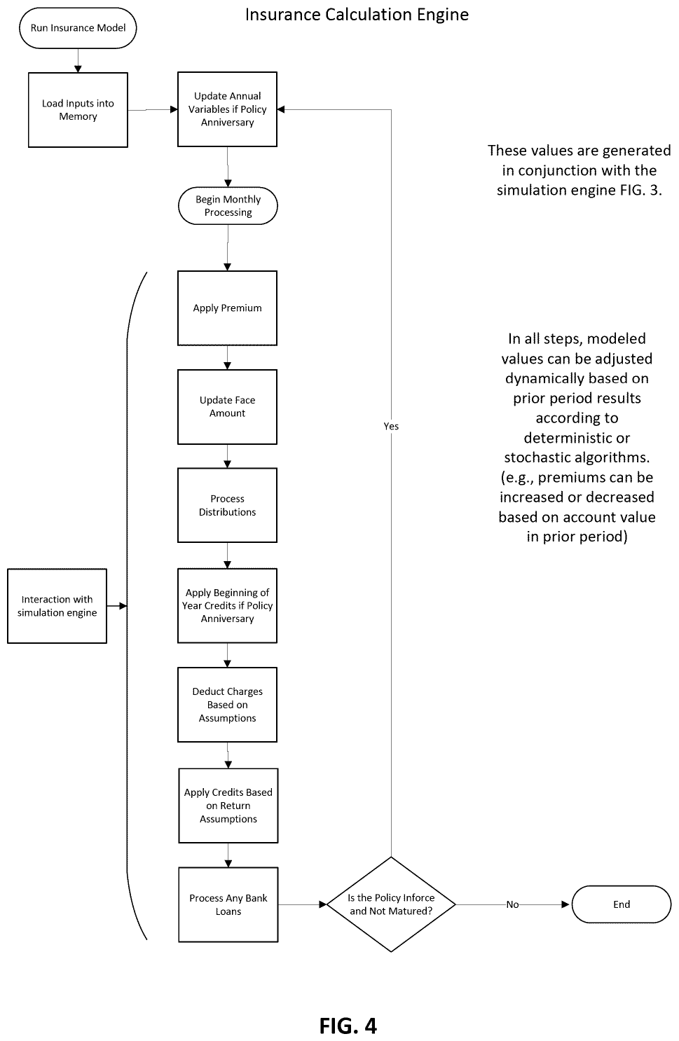

FIG. 3. Simulation Engine Workflow:
Depict the combination of economic simulations and product simulations.
Show the sampling process from historical returns or the generation of random returns.
Outline the scheduling and randomization of policyholder actions.
Show how these actions interact with policy performance dynamically.

FIG. 4. Insurance Calculation Engine:
Depicts how insurance values are projected forward.
Shows interaction with simulation engine.

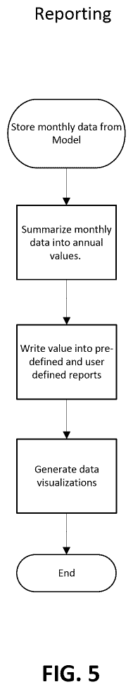

FIG. 5. Reporting and Visualization Examples:
Provide examples of pie charts, donut charts, line graphs, and scatter plots used in reports.
Show how these visualizations represent probabilities and performance metrics.

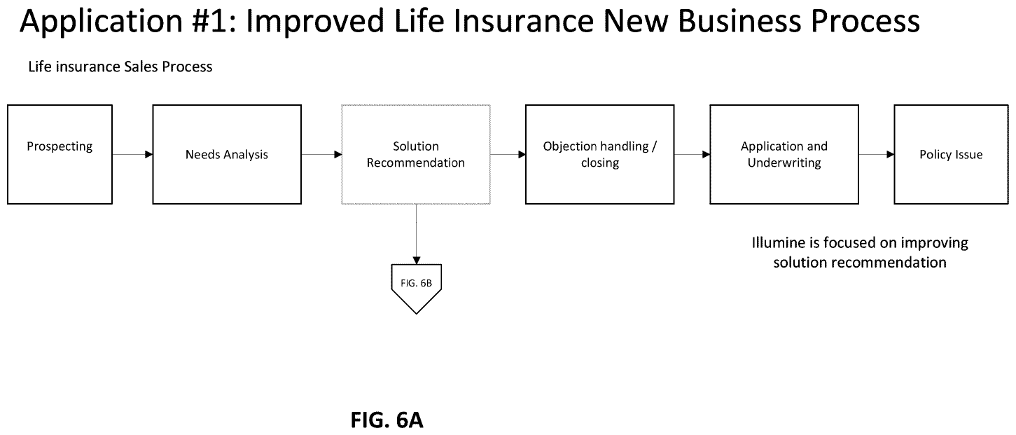

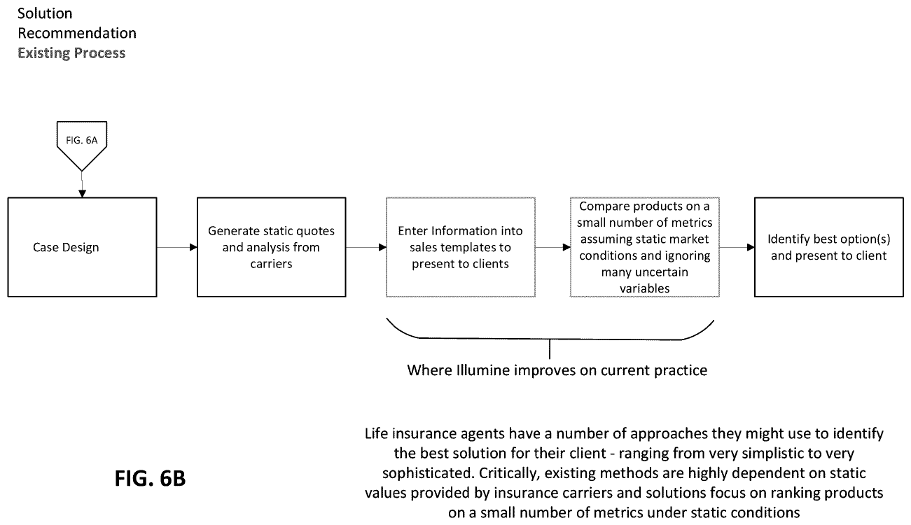

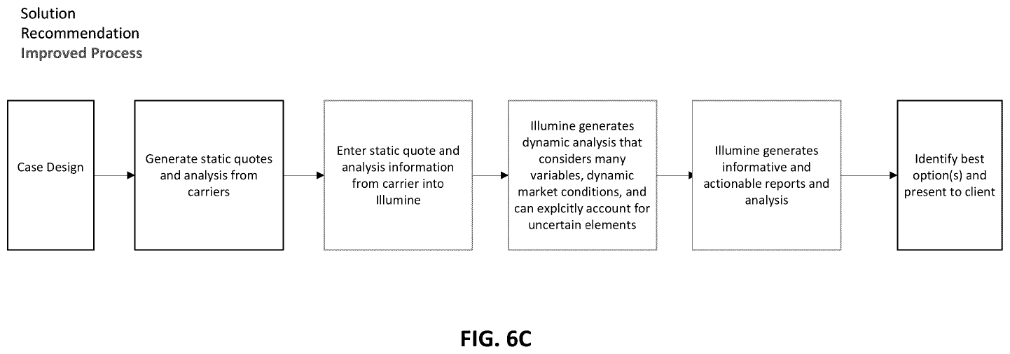

FIGS. 6A to 6C Overview of how Illumine fits within current practice:
Shows an overview of current practices for insurance policy projection.
Details how Illumine provides more complete analysis than current practice.

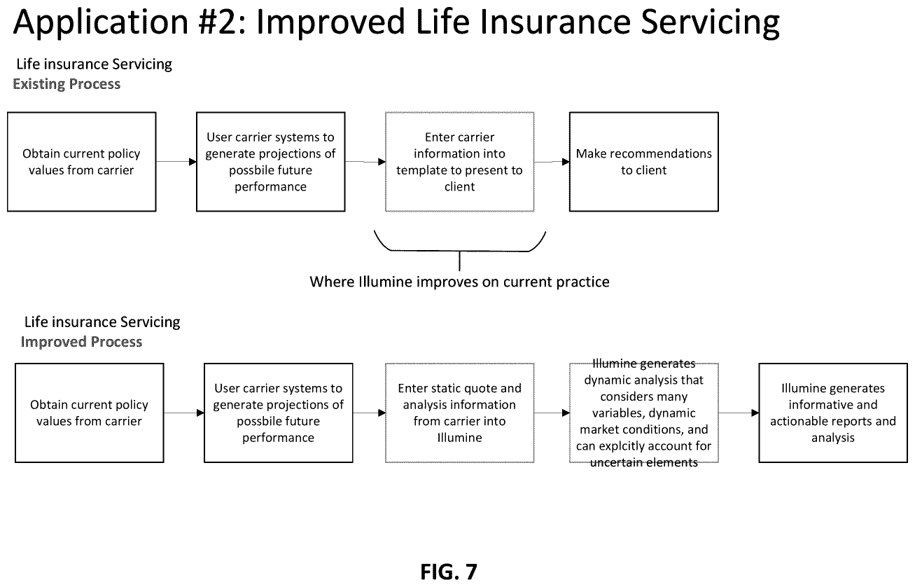

FIG. 7 Overview of how Illumine fits within current practice
Shows an overview of current practices for insurance policy projection
Details how Illumine provides more complete analysis than current practice

### Supplemental Workflows

### 1. NLP User Interaction Workflow:

Illustrate how users can input natural language queries, the processing steps using GPT, and the tool's generation of responses or actions.

### 2. Automated Report Generation Workflow:

Show the steps in automatically generating reports from simulation data, including data extraction, report drafting using GPT, and final customization.

### 3. Predictive Analytics Process:

Depict the flow of historical data input, AI-driven analysis, prediction generation, and how these predictions are used in simulations and recommendations.

### 4. Personalized Policy Recommendation Engine:

Detail the process of collecting user data, analyzing preferences and goals using AI, and generating tailored policy recommendations.

### 5. Real-Time Data Integration Framework:

Illustrate how real-time data is collected, processed, and integrated into the simulation engine to provide up-to-date insights.

### 6. Behavioral Insights and Anomaly Detection:

Show the workflow for monitoring policyholder behaviors, detecting anomalies using AI, and alerting users to potential issues.

### 7. Enhanced Visualization Generation:

Detail the process of creating advanced visualizations using GPT, including data input, visualization creation, and user interaction.

### 8. Continuous Learning Model:

Illustrate the feedback loop where the tool learns from new data and user interactions to improve its accuracy and recommendations over time.

### 9. Regulatory Compliance Monitoring:

Show the steps for monitoring regulatory changes, analyzing their impact, and adjusting simulations and reports to maintain compliance.

### DETAILED DESCRIPTION OF THE INVENTION

### Input Collection

Collect client demographic information (e.g. age, gender, insurance risk class, issue state).

Gather policy details (e.g. policy status, account value, loan balance, no lapse guarantee duration, policy crediting mechanics).

Gather other financial modeling details (e.g. interest rates, durations, and other financial balances).

### Baseline Illustration Creation

Use industry-standard mortality tables (e.g., 2015 VBA valuation basic table) to estimate life expectancy.

Adjust mortality rates based on risk class, flat extras, and table ratings.

Collect information on policy crediting mechanics (fixed and variable investment return expectations, charges, cap, floor, threshold, policy fees, multipliers, etc.).

### Model Validation and Calibration

Validate model outputs against policy illustrations.

Use a series of algorithms to estimate charges and credits from policy ledgers.

Ensure the model aligns closely with the illustration by iteratively adjusting parameters.

### Simulation Engine

Combine economic simulations with product simulations, policy owner behavior, and other stakeholder simulations.

Sample from historical returns (e.g., S&P 500) or generate random returns using various statistical models.

Simulate policy performance under thousands of different economic scenarios.

### Policyholder Behavior Modeling

Schedule or randomize policyholder, insurance company, and other stakeholder actions (e.g., premium payments, withdrawals, loans, changes to non-guaranteed contract elements).

Model interactions between party actions and policy performance dynamically.

### Reporting

Generate reports on policy sustainability probabilities (e.g., probability of policy remaining in force until certain ages).

Generate reports on strategy probability of success (e.g., Premium Finance, Split-Dollar, Non-Qualified Deferred Comp).

Provide visualizations such as pie charts, donut charts, line graphs, and scatter plots to illustrate probabilities and policy performance.

Report on internal rate of return (IRR) and expected value, accounting for taxes and opportunity costs.

Provide consolidated dashboards of key information and findings for various audiences, including financial professionals, banks, trust companies, and policy owners.

Predict various cash-flows useful in keeping a policy in good order.

### Current and Planned Enhancements

### 1. Data Privacy and Security Enhancements:

Implement advanced data privacy and security measures to protect user information and ensure compliance with data protection regulations.

### 2. User-Friendly Dashboard Customization:

Develop an intuitive dashboard for users to interact with the tool, allowing them to easily input data, run simulations, and view reports.

Include stress testing capabilities to evaluate policy performance under extreme economic conditions or worst-case scenarios.

### 3. Automated Report Generation:

AI generates comprehensive, customized reports based on simulation results, including executive summaries, detailed analyses, and visualizations.

Implement advanced graphical representations such as heat maps, 3D charts, and animated visualizations to better illustrate complex data.

GPT generates advanced visualizations and interactive dashboards, explaining complex data in a user-friendly manner.

### 4. Natural Language Processing AI (NLP-AI) for User Interaction:

Users can interact with the tool using natural language queries.

GPT-based NLP-AI capabilities explain complex policy terms, simulation results, and potential outcomes.

Integrate voice-activated commands for hands-free operation and ease of use, especially for mobile applications.

5. Integration with Financial Planning Software:

Integrate with popular financial planning and management software to provide a holistic view of the client's financial health and goals.

Add collaborative features that allow multiple users (e.g., financial advisors and clients) to work together on simulations and analyses in real time.

### 6. Automated Data Integration, Analysis, Alerts and Notifications:

Set up automated alerts and notifications for significant changes in economic conditions or policy performance that might request user action.

AI generates and analyzes various economic scenarios and policyholder behaviors, identifying the most impactful scenarios.

AI continuously collects and analyzes real-time data from financial markets, economic indicators, and policy performance.

AI monitors and analyzes policyholder behaviors, detecting anomalies or significant deviations from expected patterns.

### 7. Interactive Educational Modules:

Include educational modules to help users understand life insurance policies' underlying concepts mechanics and simulations.

Introduce gamification elements to increase user engagement and make learning about policy management more interactive and enjoyable.

### 8. Risk Assessment Tools:

Develop advanced risk assessment tools that evaluate the potential risks associated with different policy options and economic scenarios.

Introduce new performance metrics to provide a more comprehensive view of policy health and potential future performance.

### 9. Predictive Analytics:

AI analyzes historical data and predicts future trends in policy performance and economic conditions, offering proactive suggestions for policy adjustments.

AI analyzes user-specific data and preferences to recommend the best policy options and strategies to improve probabilities.

AI models continuously learn from new data and user interactions, improving the accuracy and relevance of simulations and recommendations.

AI monitors changes in regulations and automatically adjusts simulations and reports to ensure compliance.

Implement machine learning algorithms to improve the accuracy of predictions by learning from historical data and adjusting models based on observed outcomes.

Include stress testing capabilities to evaluate policy performance under extreme economic conditions or worst-case scenarios.

Provide sensitivity analysis features to show how changes in key variables (e.g., interest rates, premium payments) affect policy outcomes.

Enable comparative analysis of multiple policies or scenarios side-by-side to help users make informed decisions.

Include the ability to analyze historical performance of similar policies to provide context and benchmarks for new simulations.

Track user interactions with the tool to gather data on common usage patterns and improve the user experience over time.

Generate detailed reports comparing different scenarios, highlighting the most significant differences and their potential impact.

### 10. Mobile App Integration:

Create a mobile application version of the tool for on-the-go access, enabling users to run simulations and view reports from their smartphones or tablets.

### 11. Blockchain for Data Integrity:

Use blockchain technology to ensure data integrity and transparency in the simulation and reporting processes.

### 12. Global Market Adaptation:

Adapt the tool for use in different global markets, accounting for local regulatory environments, economic conditions, and insurance products.

1. A method for simulating and analyzing insurance policy performance comprising:
a. Collecting client demographic and policy information;
b. Creating a baseline policy illustration;
c. Validating model projections against known data;
d. Simulating policy performance under various economic scenarios;
e. Modeling policyholder behaviors dynamically; and
f. Generating reports on policy sustainability probabilities and performance metrics.

2. The method of claim 1, further comprising interfacing with external data sources via APIs to obtain up-to-date economic data.

3. The method of claim 1, wherein the simulation engine samples from historical returns or generates random returns using statistical models.

4. The method of claim 1, wherein the policyholder behaviors include one of premium payments, withdrawals, loans, or the use of external financing.

5. The method of claim 1, wherein the insurance company and other stakeholder behaviors include changes to non-guaranteed contractual elements.

6. The method of claim 1, wherein the reports include visualizations such as pie charts, donut charts, line graphs, or scatter plots.
